(19) United States
(12) Patent Application Publication
(10) Pub. No.: US 2009/0064864 A1
(43) Pub. Date: Mar. 12, 2009

(54) AIR PURIFIER ASSEMBLY

(75) Inventors: Peter Mann, Austin, TX (US); Paul Noble-Campbell, Austin, TX (US); Vincent Lam, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: ALEN CORPORATION, Austin, TX (US)

(21) Appl. No.: 11/853,864

(22) Filed: Sep. 12, 2007

(51) Int. Cl. B01D 46/00

(52) U.S. Cl. 96/223

(57) ABSTRACT

In a particular embodiment, an air purifier assembly is disclosed and can include a housing assembly. The air purifier assembly can include a first fluid communication channel within the housing assembly. The first fluid communication channel can have an air inlet formed in a back of the housing assembly and an air outlet formed in a first side of the housing assembly. Further, the air purifier assembly can include a second fluid communication channel within the housing assembly. The second fluid communication channel can have an air inlet formed in a back of the housing assembly and an air outlet formed in a second side of the housing assembly, opposite the first side of the housing.

### FIELD OF THE DISCLOSURE

The present disclosure relates generally to air purifiers. More specifically, the present disclosure relates to impeller driven air purifiers.

### BACKGROUND

Air purifiers can be used to cleanse air in interior spaces. For example, an air purifier can be placed in a bedroom, living room, or other living space in order to cleanse the air. The air purifier can include an internal fan that moves through the air purifier. One or more filters can be placed in the fluid communication channel of the air in order to remove impurities from the air. Additionally, the air can be ionized or subjected to ultraviolet (UV) light. Many air purifiers are bulky and provide airflow patterns that are disruptive to the areas surrounding the air purifiers.

Accordingly, there is a need for an improved air purifier.

### BRIEF DESCRIPTION OF THE DRAWINGS

FIG. 1 is a front plan view of an assembled air purifier in accordance with a specific embodiment of the present invention;

FIG. 2 is a front plan view of an outer housing for the air purifier of FIG. 1 in accordance with a specific embodiment of the present invention;

FIG. 3 is a back plan view of the outer housing of FIG. 1 in accordance with a specific embodiment of the present invention;

FIG. 4 is a right side plan view of the outer housing of FIG. 1 in accordance with a specific embodiment of the present invention;

FIG. 5 is a left side plan view of the outer housing of FIG. 1 in accordance with a specific embodiment of the present invention;

FIG. 6 is a top plan view of an upper panel for the outer housing of FIG. 1 in accordance with a specific embodiment of the present invention;

FIG. 7 is a front plan view of an inner housing for the air purifier of FIG. 1 in accordance with a specific embodiment of the present invention;

FIG. 8 is a back plan view of the inner housing of FIG. 1 in accordance with a specific embodiment of the present invention;

FIG. 9 is a right side plan view of the inner housing of FIG. 1 in accordance with a specific embodiment of the present invention;

FIG. 10 is a left side plan view of the inner housing of FIG. 1 in accordance with a specific embodiment of the present invention;

FIG. 11 is a cross-section view of the inner housing of FIG. 1 in accordance with a specific embodiment of the present invention taken along line 11-11 in FIG. 10;

FIG. 12 is a cross-section view of the inner housing of FIG. 1 in accordance with a specific embodiment of the present invention taken along line 12-12 in FIG. 8;

FIG. 13 is a back plan view of the assembled air purifier of FIG. 1 in accordance with a specific embodiment of the present invention;

FIG. 14 is a right side plan view of the assembled air purifier of FIG. 1 in accordance with a specific embodiment of the present invention;

FIG. 15 is a left side plan view of the assembled air purifier of FIG. 1 in accordance with a specific embodiment of the present invention; and

FIG. 16 is a bottom plan view of the assembled air purifier of FIG. 1 in accordance with a specific embodiment of the present invention.

### DETAILED DESCRIPTION OF THE DRAWINGS

In a particular embodiment, an air purifier assembly is disclosed and can include a housing assembly. The air purifier assembly can include a first fluid communication channel within the housing assembly. The first fluid communication channel can have an air inlet formed in a back of the housing assembly and an air outlet formed in a first side of the housing assembly. Further, the air purifier assembly can include a second fluid communication channel within the housing assembly. The second fluid communication channel can have an air inlet formed in a back of the housing assembly and an air outlet formed in a second side of the housing assembly, opposite the first side of the housing.

In another embodiment, an air purifier assembly is disclosed and can include a housing assembly having a bottom. A cord winding cavity can be formed in the bottom of the housing assembly. Also, a cord winding post can extend into the cord winding cavity. A cord extending from the housing assembly can be wound around the cord winding post within the cord winding cavity.

In still another embodiment, an air purifier assembly is disclosed and can include an inner housing and an outer housing surrounding the inner housing. The inner housing can have a length, LI, and the outer housing has a length, LO. LI is less than LO.

### Description of an Air Purifier

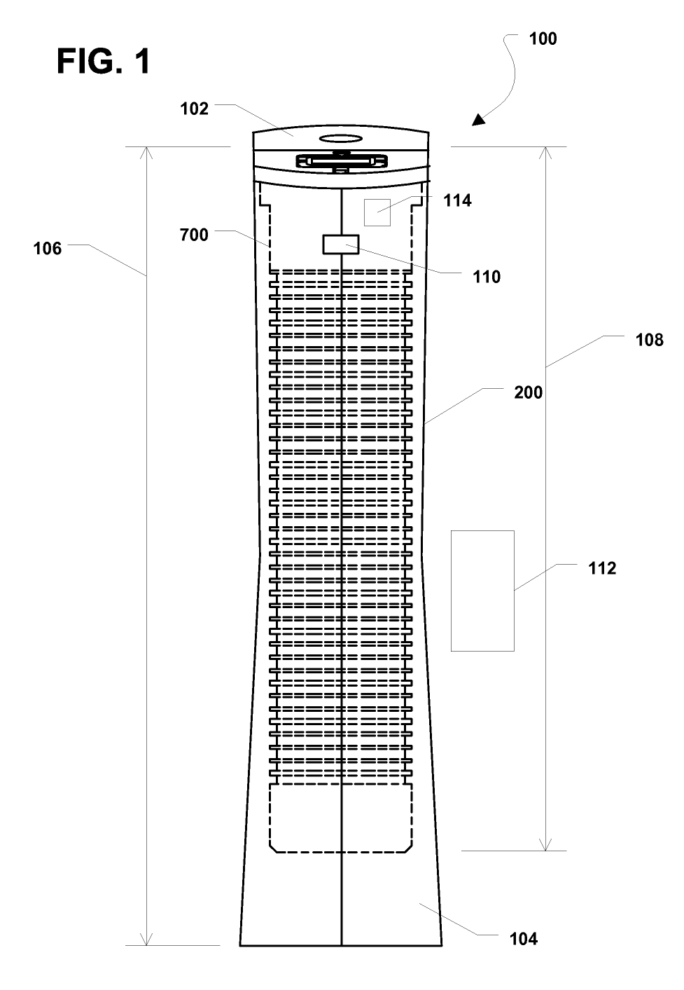

Referring to FIG. 1, an air purifier assembly is shown and is generally designated 100. As shown, the air purifier assembly 100 can include a housing assembly 102 that can include an outer housing 200 and an inner housing 700. The outer housing 200 can be hollow and generally oval in cross-section, as described in detail below. However, the outer housing 200 can be have other cross-sectional shapes, e.g., circular, square, rectangular, etc.

As shown in FIG. 1, the inner housing 700 is installed within the outer housing 200. Further, the inner housing 700 can be relatively shorter than the outer housing 200. As such, the inner housing 700 can be suspended, or hung, within the outer housing 200 so that the inner housing 700 does not reach all the way to the floor, or surface, on which the air purifier assembly 100 rests or to the bottom opening of the outer housing 200. As such, the housing assembly 102 can include a storage cavity 104 that can be formed within the outer housing 200 beneath the inner housing 700.

In a particular embodiment, the outer housing 200 has an overall length, L_{O}, 106 and the inner housing 700 has a length, L_{I}, 108. Further, a length ratio, L_{R}, that is equal to L_{I}/L_{O}. In a particular embodiment, L_{R} is less than or equal to 0.90. Alternatively, L_{R} is less than or equal to 0.85. In yet another embodiment, L_{R} is less than or equal to 0.80. In still another embodiment, L_{R} is less than or equal to 0.75. In yet still another embodiment, L_{R} is less than or equal to 0.70. In another embodiment, L_{R} is less than or equal to 0.65. Further, in another embodiment, L_{R} is less than or equal to 0.60. In another embodiment L_{R} is not less than 0.50.

FIG. 1 also shows that the air purifier assembly 100 can include an indicator 110 formed, or otherwise disposed, in the front of the air purifier assembly 100. The indicator 110 can be a light that can indicate when to change a filter, described in further detail below. Additionally, the air purifier assembly 100 can include a remote control device 112. As such, the air purifier assembly 100 can also include a receiver 114 formed in the front of the air purifier assembly 100. The receiver can be an infrared (IR) receiver, a radio frequency (RF) receiver, or a similar receiver.

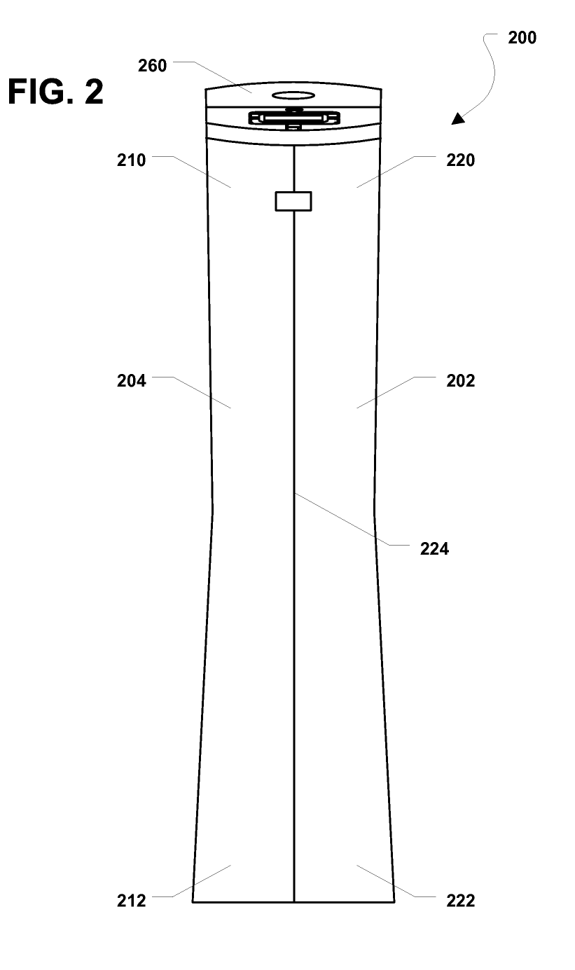

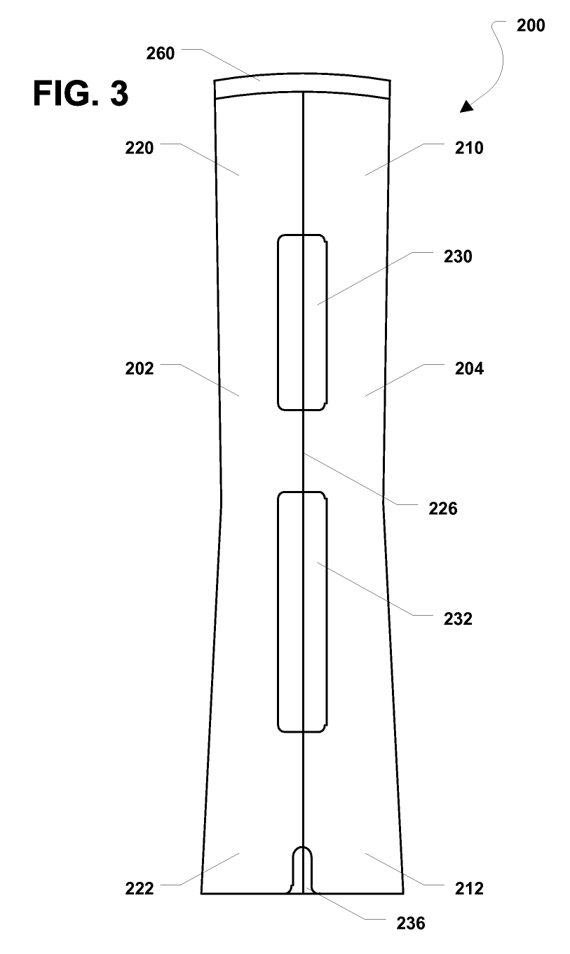

The outer housing 200 is illustrated in greater detail in FIG. 2 through FIG. 6. As shown, in FIG. 2 and FIG. 3, the outer housing 200 can include a first half 202 and a second half 204. In a particular embodiment, the outer housing 200 can be split in half, as depicted, side-to-side. Alternatively, the outer housing 200 can be split in half back-to-front, top-to-bottom, etc. Further, the outer housing 200 can be integrally formed as a single shell without having a first half and a second half.

As indicated, the first half 202 of the outer housing 200 can have a top 210 and a bottom 212. Further, the second half 204 of the outer housing 200 can have a top 220 and a bottom 214. As depicted in FIG. 2 and FIG. 3, the first half 202 can be joined to the second half 204 such that the top 210 of the first half 202 abuts the top 220 of the second half 204 and the bottom 212 of the first half 202 abuts the bottom 222 of the second half 204.

In a particular embodiment, the first half 202 of the outer housing 200 can be joined to the second half 204 of the outer housing 200 using one or more threaded fasteners, an adhesive, a welding process, or a combination thereof. Also, as indicated in FIG. 2 and FIG. 3, a front seam 224 and a back seam 226 can be formed between the first half 202 and the second half 204 of the outer housing 200.

As shown in FIG. 3, the outer housing 200 can include an upper air inlet 230 that is located near the top 210 of the first half 202 of the housing 200 and the top 220 of the second half 204 of the outer housing 200. Specifically, the upper air inlet 230 can be formed above a midpoint of the outer housing 200. Further, the outer housing 200 can include a lower air inlet 232 that is located near the bottom 212 of the first half 202 of the housing 200 and the bottom 222 of the second half 204 of the housing 200. Specifically, the lower air inlet 232 can be formed below a midpoint of the outer housing 200.

As shown, the air inlets 230, 232 span the back seam 226 and can be formed in the first half 202 of the outer housing 200 and the second half 204 of the outer housing 200. Alternatively, the air inlets 230, 232 can be offset from the back seam 226 and can be formed entirely in the first half 202 of the housing 200 or the second half 204 of the outer housing 200. FIG. 3 also shows that the outer housing 200 can be formed with a cord outlet 236 through which a cord from the inner housing 700 (not shown in FIG. 3) can pass. The cord outlet 236 is formed in the back of the outer housing 200. As such, when the air purifier 100 is properly placed near a wall, the cord outlet 236 can face toward the wall and toward an electrical outlet in the wall.

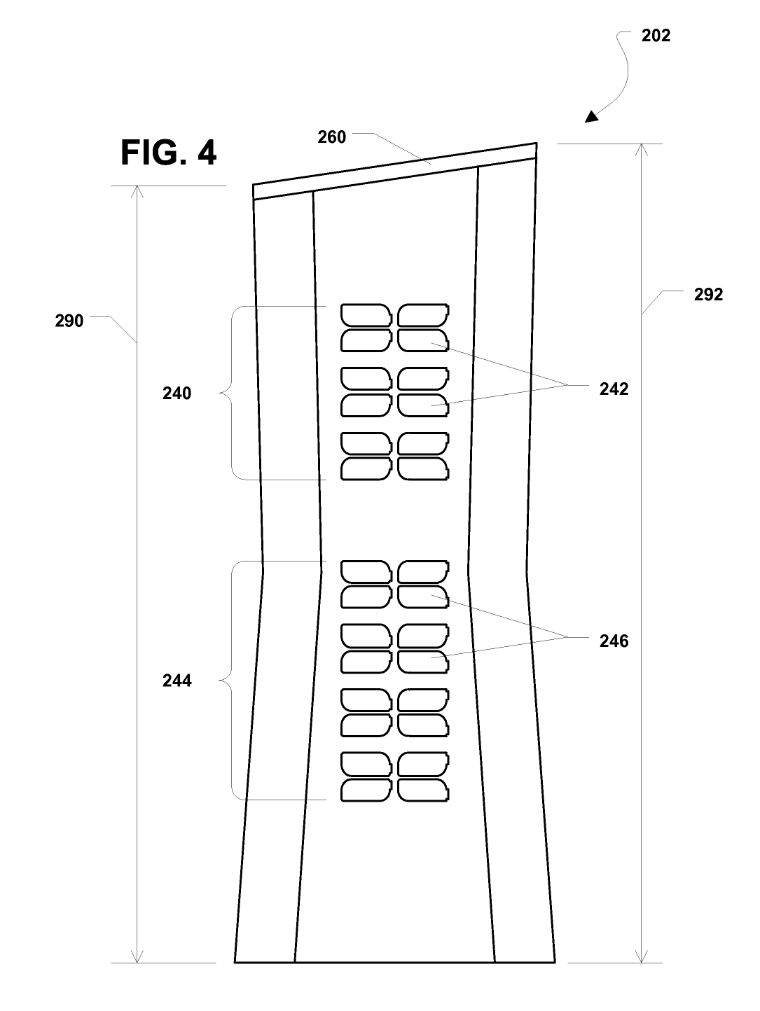

FIG. 4 shows that the first half 202 of the outer housing 200 can include an upper air outlet 240 formed by one or more openings 242 in the outer housing 200 near the top 210 of the first half 202 of the outer housing 200. Specifically, the upper air outlet 240 can be formed above a midpoint of the outer housing 200. The first half 202 of the outer housing 200 can also include a lower air outlet 244 that can be formed by one or more openings 246 in the outer housing 200 near the bottom 212 of the first half 202 of the outer housing 200. Specifically, the lower air outlet 244 can be formed below a midpoint of the outer housing 200.

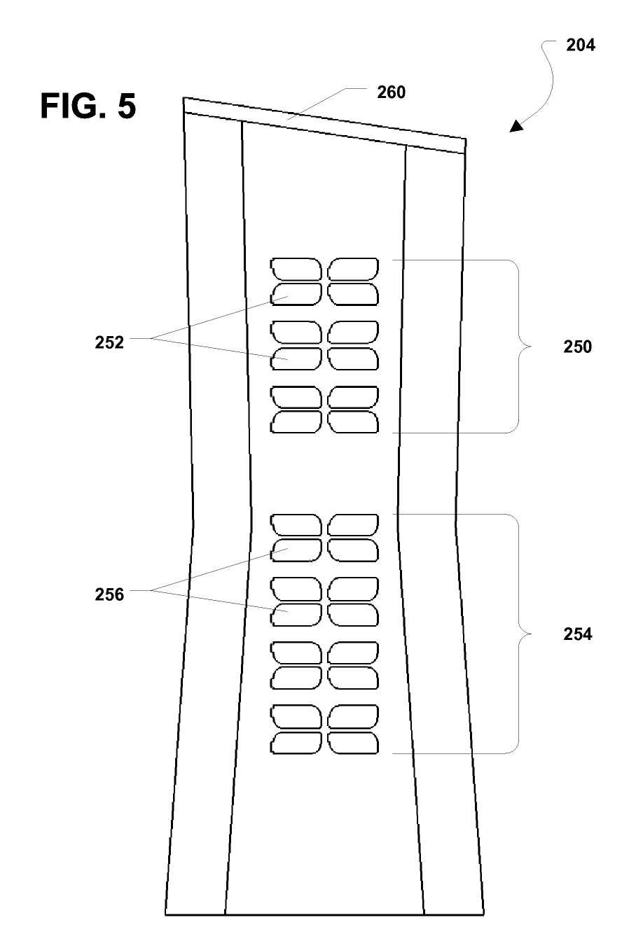

FIG. 5 indicates that the second half 204 of the outer housing 200 can include an upper air outlet 250 formed by one or more openings 252 in the outer housing 200 near the top 220 of the second half 204 of the outer housing 200. The upper air outlet 250 can be formed above a midpoint of the outer housing 200. The second half 204 of the outer housing 200 can also include a lower air outlet 254 that can be formed by one or more openings 256 in the outer housing 200 near the bottom 222 of the second half 204 of the outer housing 200. The lower air outlet 254 can be formed below a midpoint of the outer housing 200.

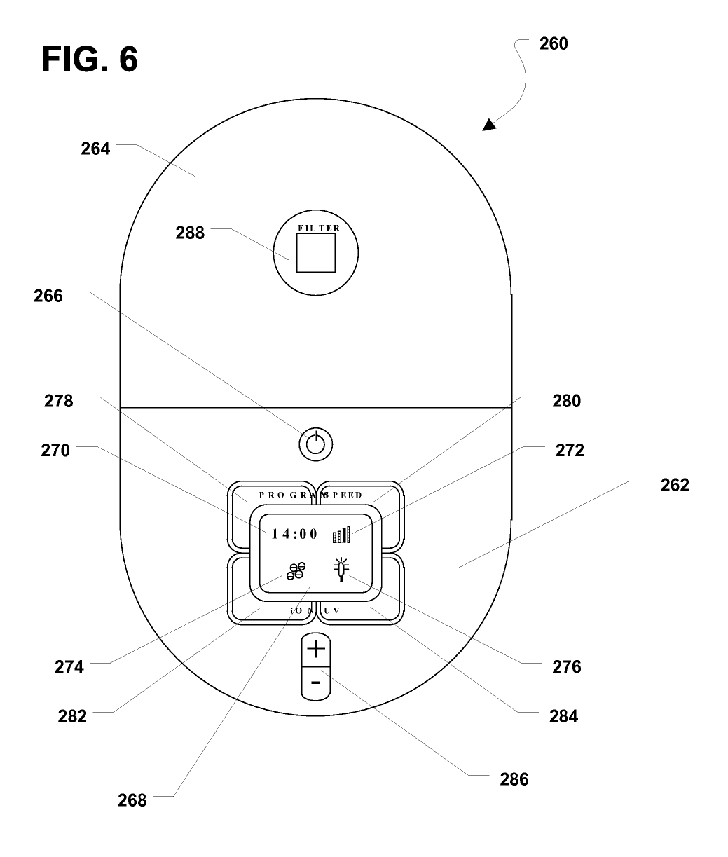

As illustrated in FIG. 2 through FIG. 6, the outer housing 200 can also include an upper panel 260 that can be attached, or otherwise affixed, to the top 210 of the first half 202 of the outer housing 200 and the top 220 of the second half 204 of the outer housing 200. FIG. 6 shows that the upper panel 260 can include a control panel 262 and a filter access door 264. In a particular embodiment, the filter access door 264 can be rotated between a closed position, shown in FIG. 2 through FIG. 6, and an open position, not shown. In the closed position, the filter access door 264 blocks access to a filter, described below, located within the inner housing 700 (not shown in FIG. 6). In the open position, the filter access door 264 can be moved, i.e., rotated, relative to the outer housing 200 so that the filter access door 264 is substantially parallel to a longitudinal axis of the outer housing 200 and access is provided to the filter within the inner housing 700.

FIG. 6 shows that the control panel 262 can include a power button 266. Further, the control panel 262 can include a display panel 268. The display panel 268 can be a light emitting diode (LED), a liquid crystal display (LCD), or a similar display. The display panel 268 can also include a time clock 270, a speed indicator 272, an ionization indicator 274, and an ultraviolet (UV) light indicator 276. The time clock 270 can indicate a programming time, i.e., run time for the air purifier assembly 100. The speed indicator 272 can indicate a fan speed of the air purifier assembly 100. The ionization indicator 274 can indicate whether the air purifier assembly 100 is ionizing air passing there through. Additionally, the UV light indicator 276 can indicate whether the air purifier assembly 100 is subjecting air passing through the air purifier assembly 100 to UV light.

As shown in FIG. 6, the control panel 262 can also include a program button 278, a speed button 280, an ion button 282, a UV button 284, and an up/down button 286. In a particular embodiment, the program button 278 and the up/down button 286 can be used to set a run time for the air purifier assembly 100. For example, a user can press the program button 278 and then, press the up/down button 286 in order to set the run time for the air purifier assembly 100. Similarly, the speed button 280 and the up/down button 286 can be used to set the speed 286 of the air purifier assembly 100. The ion button 282 can be used to turn an ionizing function within the air purifier assembly 100 on and off. Further, the UV button 284 can be used to turn a UV light function within the air purifier assembly 100 on and off.

In a particular embodiment, the entire control panel 262, or at least a portion thereof, can be backlit. As such, when a user presses one of the buttons, the backlight for the control panel 262 can be lit. Further, after a predetermined time period of no activity on the control panel 262, i.e., no user interaction with the control panel 262, the backlight for the control panel 262 can automatically turn itself off. As such, when the air purifier assembly 100 is used in a bedroom, the control panel 262 will not create any light pollution within the bedroom. Additionally, energy consumption by the control panel 262 can be minimized. In an alternative embodiment, this “sleep” feature for the air purifier assembly 100 can be deactivated when the user would like to use the backlight for the control panel 262 for a nightlight, e.g., when the user is a small child.

FIG. 6 also indicates that the filter access door 264 can include a filter change indicator light 288. In a particular embodiment, the filter change indicator light 288 can vary its color, or other visible characteristic based upon how dirty the filter is. For example, the filter change indicator light 288 can glow green when the filter is clean and does not need to be changed. The filter change indicator light 288 can glow orange when the filter is becoming dirty. Moreover, the filter change indicator light 288 can glow red when the filter needs to be changed.

Referring back to FIG. 4, the outer housing 200 can have a front length, L_{F}, 290 and a back length, L_{B}, 292. L_{B} is equal to the overall length, L_{O}, described above. Further, a front-to-back length ratio, L_{RFB}, that is equal to L_{F}/L_{B}. In a particular embodiment, L_{RFB} is less than or equal to 0.95. Alternatively, L_{R} is less than or equal to 0.95. In yet another embodiment, L_{RFB} is less than or equal to 0.80. In still another embodiment, L_{R} is less than or equal to 0.85. In yet still another embodiment, L_{RFB} is less than or equal to 0.80. In another embodiment, L_{RFB} is less than or equal to 0.75. Further, in another embodiment, L_{RFB} is not less than 0.60.

The height differential between the front and the back of the outer housing 200 causes the top of the outer housing 200 to be slanted, or angled, with respect to the bottom of the outer housing 200 to form a top angle. In a particular embodiment, the top angle can be at least ten degrees (10°). In another embodiment, the top angle can be at least fifteen degrees (15°). In still another embodiment, the top angle can be at least twenty degrees (20°). In yet another embodiment, the top angle can be at least twenty-five degrees (25°). In another embodiment, the top angle is not greater than thirty degrees (30°).

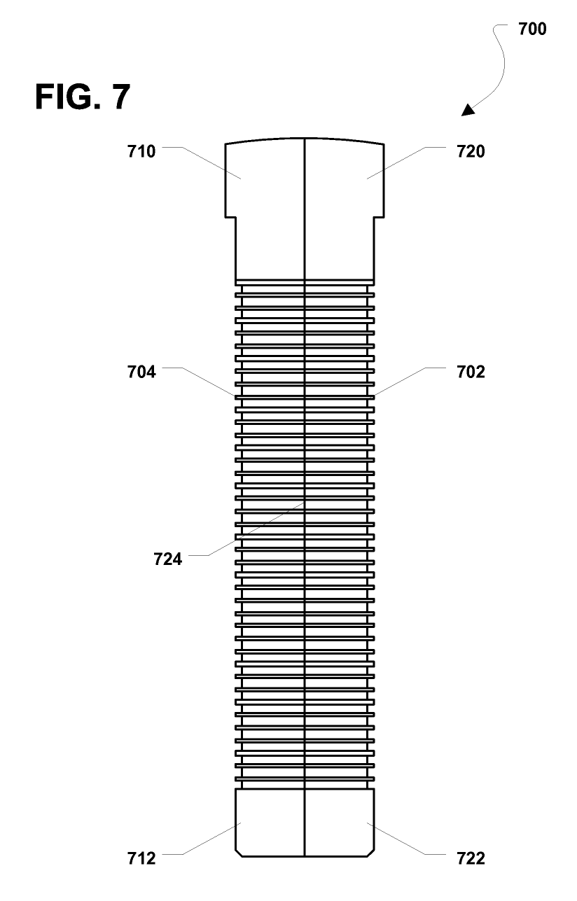

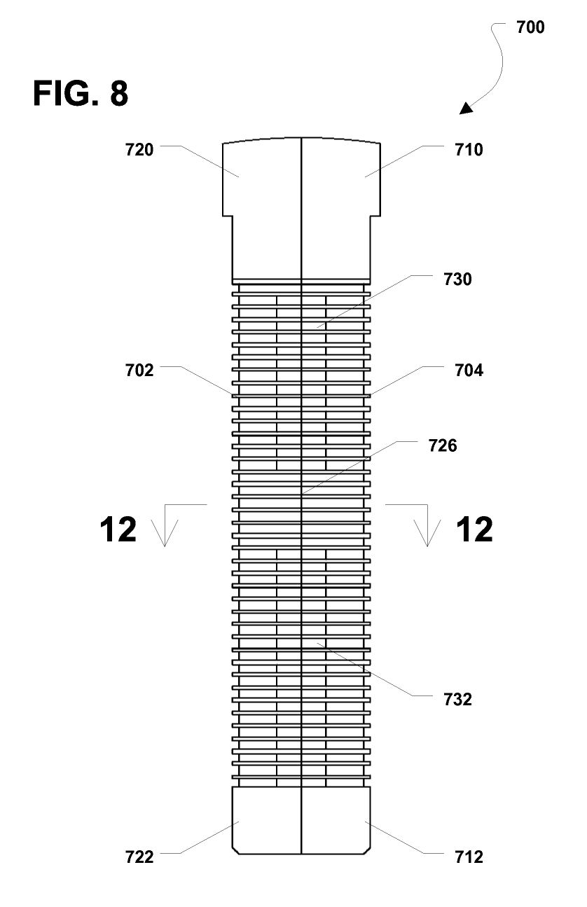

Referring now to FIG. 7 through 13, the inner housing 700 is shown. FIG. 7 depicts the front of the inner housing 700 and FIG. 8 depicts the back of the inner housing 700. As shown, in FIG. 7 and FIG. 8, the inner housing 700 can half a first half 702 and a second half 704. The first half 702 of the inner housing 700 can have a top 710 and a bottom 712. Further, the second half 704 of the inner housing 700 can have a top 720 and a bottom 714. As depicted in FIG. 7 and FIG. 8, the first half 702 can be joined to the second half 704 such that the top 710 of the first half 702 abuts the top 720 of the second half 704 and the bottom 712 of the first half 702 abuts the bottom 722 of the second half 704.

In a particular embodiment, the inner housing 700 can be split in half, as depicted, side-to-side. Alternatively, the inner housing 700 can be split in half back-to-front, top-to-bottom, etc. Further, the inner housing 700 can be integrally formed as a single shell without having a first half and a second half.

In a particular embodiment, the first half 702 of the inner housing 700 can be joined to the second half 704 of the inner housing 700 using one or more threaded fasteners, an adhesive, the like, or a combination thereof. Also, as indicated in FIG. 7 and FIG. 8, a front seam 724 and a back seam 726 can be formed between the first half 702 and the second half 704 of the inner housing 700.

As shown in FIG. 8, the inner housing 700 can include an upper air inlet 730 that is located near the top 710 of the first half 702 of the inner housing 700 and the top 720 of the second half 704 of the housing 700. Specifically, the upper air inlet 730 can be formed above a midpoint of the inner housing 700. Further, the inner housing 700 can include a lower air inlet 732 that is located near the bottom 712 of the first half 702 of the housing 700 and the bottom 722 of the second half 704 of the housing 700. Specifically, the lower air inlet 732 can be formed below a midpoint of the inner housing 700.

As shown, the air inlets 730, 732 span the back seam 726 and are formed in the first half 702 of the housing 700 and the second half 704 of the housing 700. Alternatively, the air inlets 730, 732 can be offset from the back seam 726 and can be formed entirely in the first half 702 of the inner housing 700 or the second half 704 of the inner housing 700.

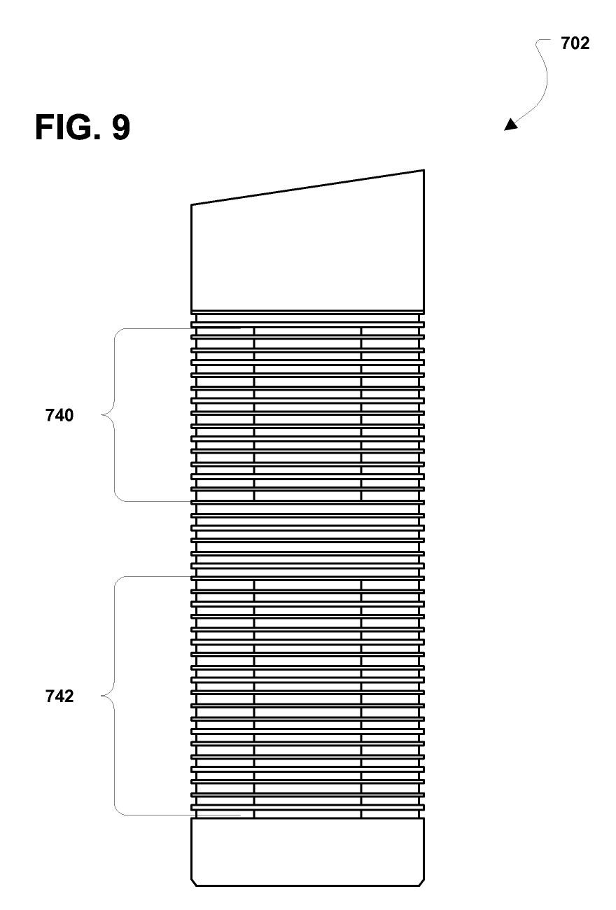

FIG. 9 shows that the first half 702 of the inner housing 700 can include an upper air outlet 740 near the top 710 of the first half 702 of the inner housing 700. The upper air outlet 740 can be formed above a midpoint of the inner housing 700. The first half 702 of the inner housing 700 can also include a lower air outlet 742 near the bottom 712 of the first half 702 of the inner housing 700. The lower air outlet 742 can be formed below a midpoint of the inner housing 700.

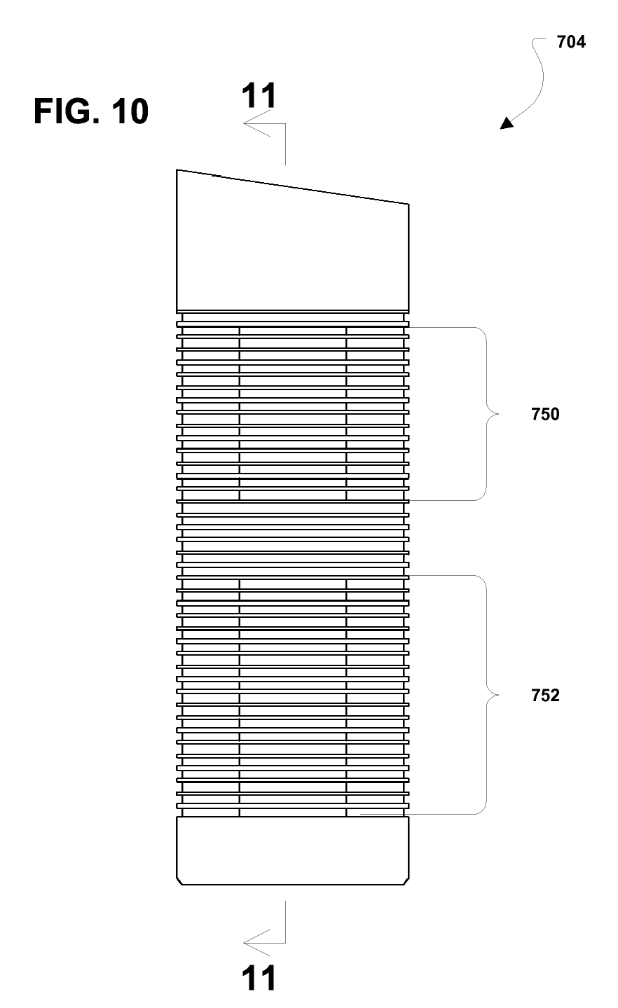

FIG. 10 indicates that the second half 704 of the inner housing 700 can include an upper air outlet 750 near the top 720 of the second half 704 of the inner housing 700. The upper air outlet 750 can be formed above a midpoint of the inner housing 700. The second half 704 of the inner housing 700 can also include a lower air outlet 754 near the bottom 722 of the second half 704 of the inner housing 700. The lower air outlet 754 can be formed below a midpoint of the inner housing 700.

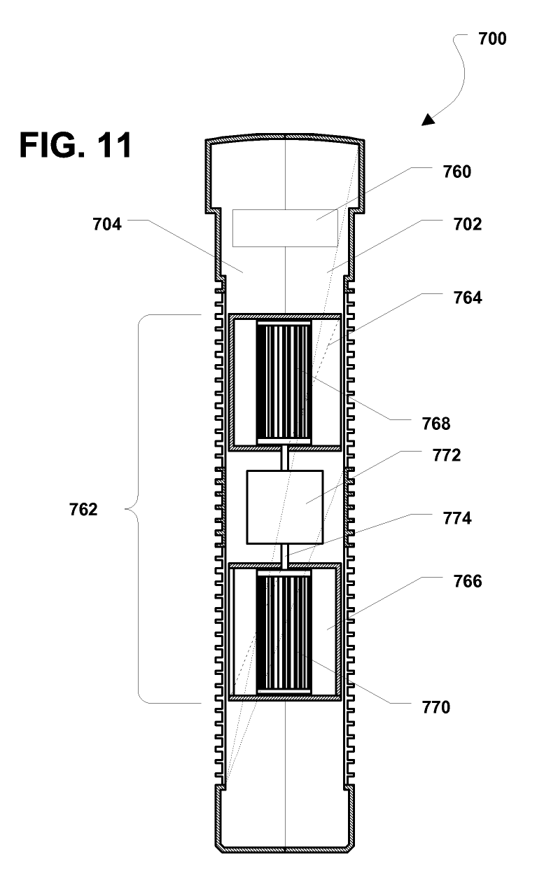

FIG. 11 shows that the inner housing 700 can include a controller 760 installed therein. The controller 760 can be coupled to the various electrical components installed in the upper panel 260 of the inner housing 200 that operate the air purifier 100. FIG. 11 also indicates that a fan assembly 762 can be installed within the housing 700. The fan assembly 762 can include an upper fan housing 764 and a lower fan housing 766. An upper fan blade 768 can be installed within the upper fan housing 764 and a lower fan blade 770 can be installed within the lower fan housing 766. A fan motor 772 can be installed between the upper fan housing 764 and the lower fan housing 766. The fan motor 772 can include a drive shaft 774 that extends from the upper fan blade 768 through the fan motor 772 and into the lower fan blade 770. As such, when the fan motor 772 is energized, the fan blades 768, 770 can rotate in unison and can drive air through the air purifier assembly 100.

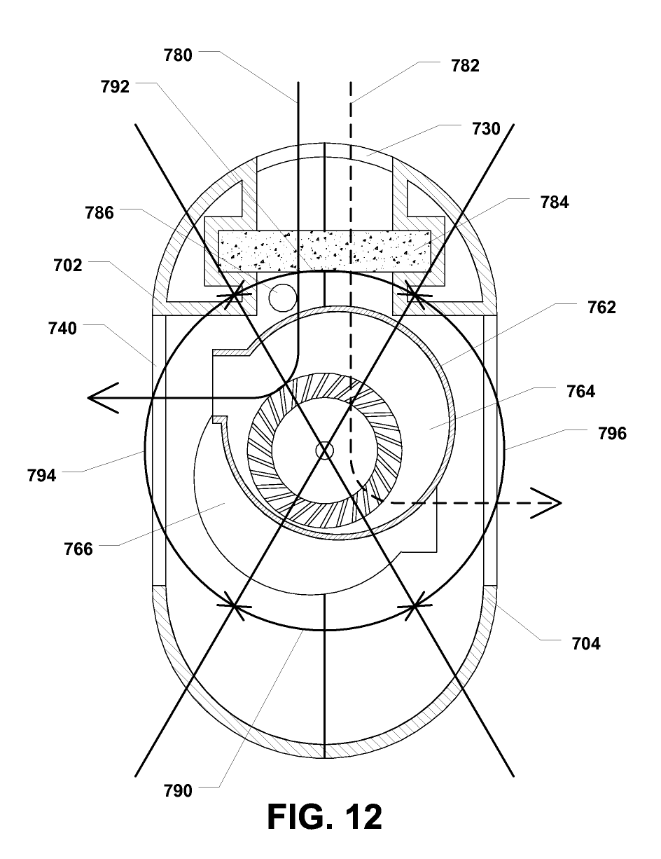

As shown in FIG. 12, the fan assembly 762 can include a first fluid communication channel 780 and a second fluid communication channel 782. Each communication channel 780, 782 can be generally perpendicular. In other words, air flowing through the center of each communication channel 780, 782 can travel along a path that is substantially perpendicular.

FIG. 12 shows that a filter 784 can be installed along the first fluid communication channel 780 and the second fluid communication channel 782 upstream from the fan assembly 762. The filter 784 can extend along the length of the inner housing 700 so that it can filter air flowing through both fluid communication channels 780, 782. A UV light 786 can be installed along the first fluid communication channel 780 and the second fluid communication channel 782 between the filter 784 and the fan assembly 762.

In a particular embodiment, air flowing through the first fluid communication channel 780 moves through the upper air inlet 230 (not shown in FIG. 12) of the outer housing 200 (not shown in FIG. 12), through the upper air inlet 730 of the inner housing 700, through the filter 784, through the upper fan housing 764 (from the top of the upper fan housing 764 to the side of the upper fan housing 764), through the upper air outlet 740 formed in the first half 702 of the inner housing 700, and through the upper air outlet 240 (not shown in FIG. 12) formed in the first half 202 (not shown in FIG. 12) of the outer housing 200 (not shown in FIG. 12), where the air exits the air purifier assembly 100.

Air flowing through the second fluid communication channel 782 moves through the lower air inlet 232 (not shown in FIG. 12) of the outer housing 200, through the lower air inlet 732 (not shown in FIG. 12) of the inner housing 700, through the filter 784, through the lower fan housing 766 (from the bottom of the lower fan housing 766 to the side of the lower fan housing 766), through the lower air outlet 752 (not shown in FIG. 12) formed in the second half 704 of the inner housing 700, and through the lower air outlet 252 (not shown in FIG. 12) formed in the second half 204 (not shown in FIG. 12) of the outer housing 200 (not shown in FIG. 12), where the air exits the air purifier assembly 100.

In short, air moving along the first fluid communication channel 780 enters the air purifier assembly 100 from a back quadrant 790 of the air purifier assembly 100 and exits the air purifier assembly 100 from a first side quadrant 792 of the air purifier assembly 100. Moreover, air moving along the second fluid communication channel 782 enters the air purifier assembly 100 from the back quadrant 790 of the air purifier assembly 100 and exits the air purifier assembly 100 from a second side quadrant 794 of the air purifier assembly 100. The exit of the first fluid communication channel 780 is substantially opposite the exit of the second fluid communication channel 782. Air does not exit the air purifier assembly 100 via a front quadrant 796.

In a particular embodiment, the back quadrant 790 and the front quadrant 796 are substantially equal in size. Further the back quadrant 790 and the front quadrant 796 span an arc that is less than or equal to ninety degrees (90°). In another embodiment, the back quadrant 790 and the front quadrant 796 span an arc that is less than or equal to eighty degrees (80°). In yet another embodiment, the back quadrant 790 and the front quadrant 796 span an arc that is less than or equal to seventy degrees (70°). In still another embodiment, the back quadrant 790 and the front quadrant 796 span an arc that is less than or equal to eighty degrees (60°). In another embodiment, the back quadrant 790 and the front quadrant 796 span an arc that is not less than fifty degrees (50°).

In a particular embodiment, the first side quadrant 792 and the second side quadrant 794 are substantially equal in size. Further the first side quadrant 792 and the second side quadrant 794 span an arc that is greater than or equal to ninety degrees (90°). In another embodiment, the first side quadrant 792 and the second side quadrant 794 span an arc that is greater than or equal to one hundred degrees (100°). In yet another embodiment, the first side quadrant 792 and the second side quadrant 794 span an arc that is greater than or equal to one hundred ten degrees (110°). In still another embodiment, the first side quadrant 792 and the second side quadrant 794 span an arc that is greater than or equal to one hundred twenty degrees (120°). In another embodiment, the first side quadrant 792 and the second side quadrant 794 span an arc that is not greater than one hundred thirty degrees (130°).

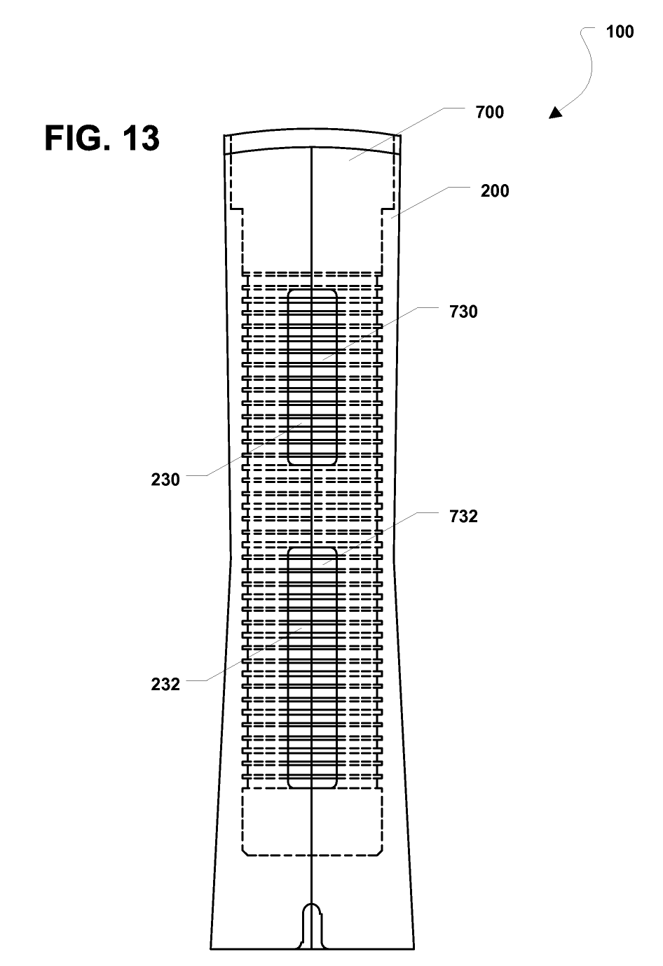

Referring now to FIG. 13 through FIG. 15, the air purifier assembly 100 is shown as assembled. In a particular embodiment, the inner housing 700 can be opaque and the inner housing can be transparent or translucent. Further, a light (not shown) can be installed between the outer housing 200 and the inner housing 700. The light can be used as a nightlight or as an indicator light similar to the filter change indicator light 288 (not shown in FIG. 13), described above.

As shown in FIG. 13, the upper air inlet 232 of the outer housing 200 is substantially aligned with the upper air inlet 732 of the inner housing 700. The lower air inlet 234 of the outer housing 200 is substantially aligned with the lower air inlet 734 of the inner housing 700.

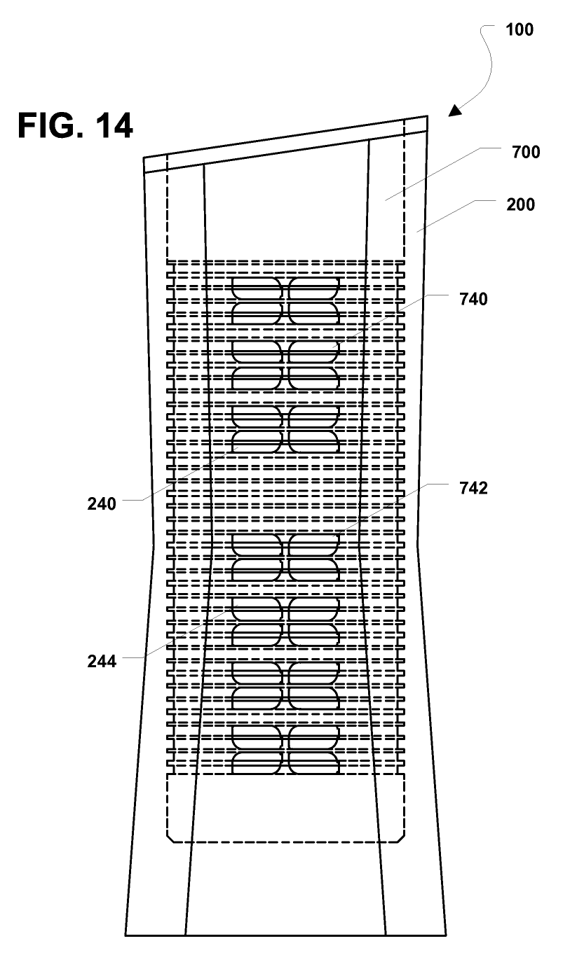

FIG. 14 shows that the upper air outlet 240 of the first half 202 of the outer housing 200 is substantially aligned with the upper air outlet 740 of the first half 702 of the inner housing 700. The lower air outlet 244 of the first half 202 of the outer housing 200 is substantially aligned with the lower air outlet 742 of the first half 702 of the inner housing 700.

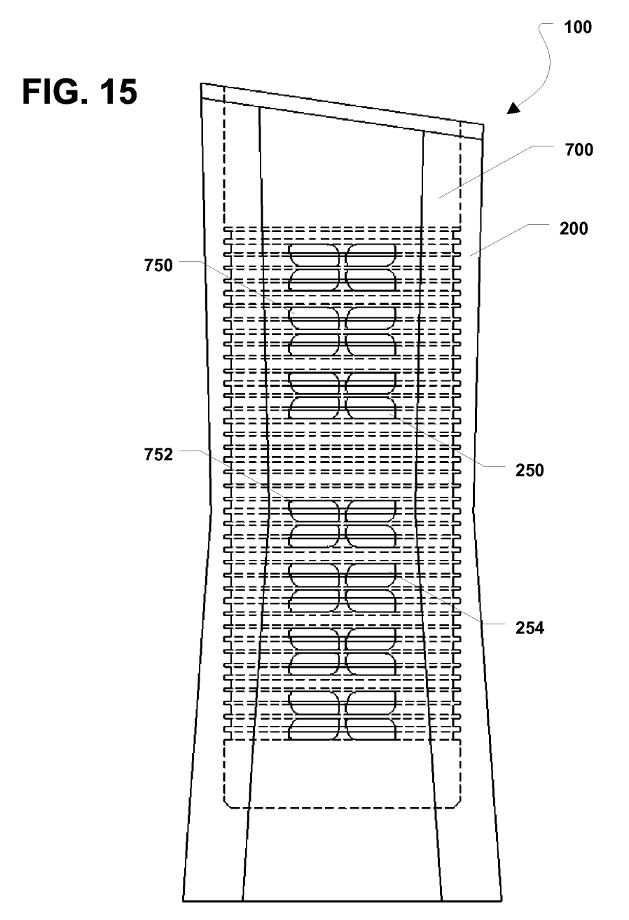

FIG. 15 indicates that the upper air outlet 250 of the second half 204 of the outer housing 200 is substantially aligned with the upper air outlet 750 of the second half 704 of the inner housing 700. The lower air outlet 254 of the second half 204 of the outer housing 200 is substantially aligned with the lower air outlet 752 of the second half 704 of the inner housing 700.

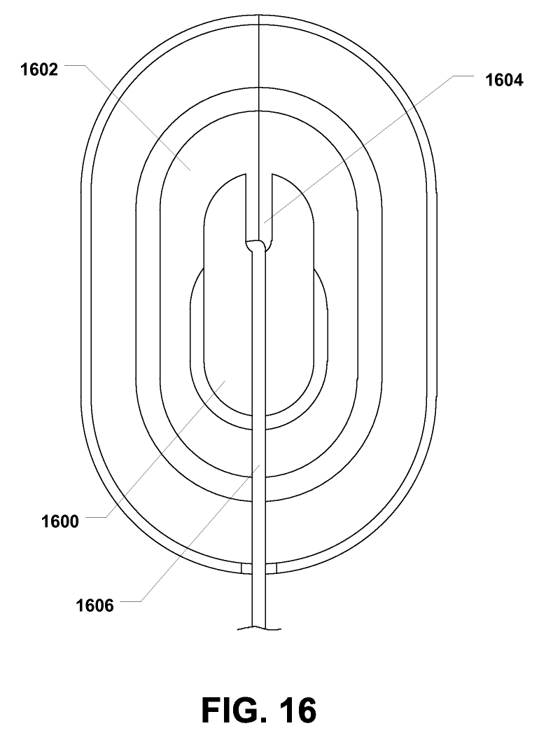

Referring to FIG. 16, a bottom of the air purifier assembly 100 is shown. FIG. 16 shows that the bottoms 212, 222 of the halves 202, 204 of the outer housing 200 and the bottoms 712, 722 of the halves 702, 704 of the inner housing 700. FIG. 16 shows that the air purifier assembly 100 can include a cord winding post 1600. The cord winding post 1600 can be surrounded by a cord winding cavity 1602 that can extend into the inner housing 700, i.e., from the bottom up. Additionally, the cord winding post 1600 can include a cord locking notch 1604.

As shown, the cord winding post 1600 and the cord winding cavity 1602 can be formed by the bottoms 712, 722 of the halves 702, 704 of the inner housing 700. A cord 1606 can extend from the inner housing 700, e.g., from the controller 760 installed therein. The cord 1606 can be wound around the cord winding post 1600 and pulled through the cord locking notch 1604. Thereafter, the cord 1606 can be pulled through the cord outlet 236 formed in the outer housing 200.

### Conclusion

With the configuration of embodiments described above, embodiments described herein provide an air purifier that is relatively unobtrusive. Further, the air flow patterns provide by embodiments herein can be configured to flow along a wall and not from a front face of air purifier. As such, when placed along a wall, air flow along the wall in both directions can be maximized. Further, when placed in a corner air flow along both walls meeting at the corner can be maximized. Additionally, the air flow patterns of an embodiment described herein minimizes the disruption of air directly in front of the air purifier. As such, a user in front of the air purifier may not be disturbed by air flowing from the air purifier.

Additionally, embodiments described herein provide a storage cavity in the bottom of the air purifier. The storage cavity can be used to store excess cord. As such, the air purifier can be placed near a receptacle and the excess cord can be wound inside the air purifier to substantially minimize the likelihood of someone tripping over the excess cord. The cavity formed in one or more embodiments can also allow the air purifier to be disposed directly over a floor receptacle without any excess cord extending from the housing of the air purifier. As such, the aesthetics associated with using such an air purifier are substantially enhanced. Further, the shape of embodiments described herein can allow relatively easy viewing of the control panel.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. An air purifier assembly, comprising:
a housing assembly;
a first fluid communication channel within the housing assembly, wherein the first fluid communication channel has an air inlet formed in a back of the housing assembly and an air outlet formed in a first side of the housing assembly, wherein the back of the housing includes a cord outlet; and
a second fluid communication channel within the housing assembly, wherein the second fluid communication channel has an air inlet formed in a back of the housing assembly and an air outlet formed in a second side of the housing assembly, opposite the first side of the housing.

2. The air purifier assembly of claim 1, wherein the housing assembly comprises an inner housing and an outer housing.

3. The air purifier assembly of claim 2, wherein the inner housing comprises an upper air inlet formed in a back of the inner housing, a lower air inlet formed in the back of the inner housing, an upper air outlet formed in a first side of the inner housing, and a lower air outlet formed in a second side of the inner housing.

4. The air purifier assembly of claim 3, wherein the outer housing comprises an upper air inlet formed in a back of the outer housing, a lower air inlet formed in the back of the outer housing, an upper air outlet formed in a first side of the outer housing, and a lower air outlet formed in a second side of the outer housing;

5. The air purifier assembly of claim 4, wherein the first fluid communication channel includes the upper air inlet of the outer housing, the upper air inlet of the inner housing, the upper air outlet of the inner housing, and the upper air outlet of the outer housing.

6. The air purifier assembly of claim 5, wherein the second fluid communication channel includes the lower air inlet of the outer housing, the lower air inlet of the inner housing, the lower air outlet of the inner housing, and the lower air outlet of the outer housing.

7. The air purifier assembly of 1, further comprising a fan assembly, wherein the fan assembly includes an upper fan housing installed along the first fluid communication channel and a lower fan housing installed along the second fluid communication channel.

8. The air purifier assembly of claim 1, further comprising a filter installed along the first fluid communication channel and the second fluid communication channel.

9. The air purifier assembly of claim 1, further comprising a control panel, wherein the control panel includes a backlight and wherein the backlight is configured to turn on when a button on the control panel is pressed.

10. The air purifier assembly of claim 9, wherein the backlight is configured to automatically turn off after a predetermined period of button inactivity on the control panel.

11. An air purifier assembly, comprising:
a housing assembly having a bottom;
a cord winding cavity formed in the bottom of the housing assembly; and
a cord winding post extending into the cord winding cavity, wherein a cord extending from the housing assembly can be wound around the cord winding post within the cord winding cavity.

12. The air purifier assembly of claim 11, wherein the housing assembly comprises an inner housing and an outer housing surrounding the inner housing.

13. The air purifier assembly of claim 12, wherein the inner housing is hung inside the outer housing so that the inner housing does not touch a surface on which the air purifier assembly rests.

14. The air purifier assembly of claim 13, wherein the cord winding cavity is formed in a bottom of the inner housing.

15. (canceled)

16. (canceled)

17. (canceled)

18. (canceled)

19. (canceled)

20. (canceled)

21. (canceled)

22. (canceled)

23. (canceled)

24. An air purifier assembly, comprising:
an inner housing; and
an outer housing surrounding the inner housing, wherein the inner housing has a length, L_{I}, and the outer housing has a length, L_{O}, and wherein L_{I} is less than L_{O}.

25. The air purifier assembly of claim 24, wherein the outer housing is configured to rest on a surface and wherein the inner housing hangs inside the outer housing and does not touch the surface.

26. The air purifier assembly of claim 25, wherein a length ratio, L_{R}, equal to L_{I} divided by L_{O} is less than or equal to 0.90.

27. The air purifier assembly of claim 26, wherein L_{R} is less than or equal to 0.85.

28. The air purifier assembly of claim 27, wherein L_{R} is less than or equal to 0.80.

29. The air purifier assembly of claim 28, wherein L_{R} is less than or equal to 0.75.

30. The air purifier assembly of claim 29, wherein L_{R} is less than or equal to 0.70.

31. The air purifier assembly of claim 30, wherein L_{R} is less than or equal to 0.65.

32. The air purifier assembly of claim 31, wherein L_{R} is less than or equal to 0.60.

33. The air purifier assembly of claim 32, wherein L_{R} is not less 0.50.
